(19) United States
(12) Patent Application Publication
(10) Pub. No.: US 2016/0042321 A1
(43) Pub. Date: Feb. 11, 2016

(54) SYSTEMS AND METHODS FOR PROVIDING LOGISTICS DATA

(71) Applicant: WEFT, INC., Cambridge, MA (US)

(72) Inventor: Marc Held, Cambridge, MA (US)

(21) Appl. No.: 14/822,250

(22) Filed: Aug. 10, 2015

Related U.S. Application Data
(60) Provisional application No. 62/035,749, filed on Aug. 11, 2014.

(51) Int. Cl. G06Q 10/08

(52) U.S. Cl. CPC G06Q 10/08355; G06Q 10/0838

(57) ABSTRACT

The invention provides systems and methods for monitoring logistics data associated with delivery of cargo and providing one or more suggested actions to a member of a supply chain for increasing the likelihood of on-time delivery of the cargo based on the logistics data.

### CROSS-REFERENCE TO RELATED APPLICATIONS

This application claims the benefit of, and priority to, U.S. Provisional Application Ser. No. 62/035,749, filed Aug. 11, 2014, the content of which is incorporated by reference herein in its entirety.

### FIELD OF THE INVENTION

The invention generally relates to systems and methods for monitoring logistics data associated with delivery of cargo and providing one or more suggested actions to a member of a supply chain for increasing the likelihood of on-time delivery of the cargo based on the logistics data.

### BACKGROUND

A massive amount of cargo is being processed and transported each day, and the process of moving the cargo to a final destination often involves a complex interaction of many components. To have predictability and to keep businesses running smoothing, it is important for members in a supply chain to have visibility into the shipping process by being able to track the movement of cargo. Typically, two cargo tracking methods have been used. One approach involves reporting the arrival or departure of cargo and recording the identity of the cargo, the location, the time, and the status. That approach has been used for cargo tracking by delivery companies, such as the U.S. Postal Service, United Parcel Service, AirRoad, or FedEx. Another approach uses a GPS-based vehicle tracking system to locate the vehicle that contains the package and record it in a real-time database.

Regardless of the approach used, a problem with those tracking systems is that members in the supply chain are passive participants in the process. That is, those tracking systems generally provide location information with regard to the shipment status of cargo, but do not allow any member along a supply chain to affect the shipping process in real-time. For example, current tracking systems and services only monitor the handling and movement of cargo, from a point of origin to an intended destination. Tracking systems may generally provide alerts to the member of a supply chain when: a piece of cargo is being processed at a facility and readied for shipment; the piece of cargo is being loaded on a vehicle, container, or the like and is shipped off for delivery; the piece of cargo is currently in transit; and the piece of cargo has arrived at the destination. In such systems, members of the supply chain have no input regarding the shipment process and cannot communicate with the shippers to make modifications to the shipment of the cargo. Accordingly, tracking systems and services limit members of a supply chain from taking an active role in the shipping process, which can ultimately lead to increased costs, delays in delivery, loss of goods, and the loss of clientele.

### SUMMARY

The invention provides systems and methods for increasing the likelihood of an on-time delivery of cargo by delivering predictive data and suggestive actions that allow a member in a supply chain to be an active participate in the shipping process. Systems and methods of the invention gather real-time data of vehicles that transport cargo as well as real-time data about destinations for the cargo. Those sets of data are combined to provide predictive insight to parties at different points along the supply chain. A distinguishing feature of the systems and methods of the invention is that they provide real-time actionable solutions based on the data they collect. In contrast, other tracking companies simply track movement of cargo, and do not suggest supply chain decisions that should be made based on that data. Accordingly, the systems and methods of the invention allow people in the supply chain to make real-time decisions, e.g., adjust routes and schedules, in order to increase the likelihood of an on-time delivery.

Aspects of the invention are accomplished by receiving (either periodically or continuously) a variety of different data, such as data associated with cargo, data associated with intermediate and/or final destinations of the cargo, and data associated with a vehicle transporting the cargo. In one aspect, a first set of data associated with one or more vehicles is received. The first set of data may include, but is not limited to, an identity of the vehicle, location of the vehicle, fuel consumption of the vehicle, environment around the vehicle, environment within the vehicle, movement of the vehicle, capacity of the vehicle, operational status of the vehicle, itinerary of the vehicle, owner of the vehicle, operator of the vehicle, and a combination thereof. A second set of data associated with one or more destinations for the cargo is also received. The second set of data may include, but is not limited to, an identity of the destination, location of the destination, overall capacity of the destination, current capacity of the destination, seasonality of the destination, operational status of the destination, schedule of the destination, operator of the destination, current weather at the destination, predicted weather at the destination, current working conditions at the destination, predicted working conditions at the destination, location of one or more types of vehicles arriving at the destination, and a combination thereof.

At least the first and second sets of data are analyzed and delivery data is generated. The delivery data generally relates to a scheduled delivery for the cargo. In some instances, the tracking service may allow a member of a supply chain (e.g., of a manufacturer/distributor of cargo) to access the service and have visibility to the delivery data. Accordingly, the member of a supply chain may be provided the most up-to-date calculation of an estimated scheduled delivery for their cargo. Furthermore, a suggested action may be provided to the member of a supply chain based on the delivery data, in which the suggested action is intended to increase the likelihood of an on-time delivery of the cargo. For example, based on the delivery data, it may be concluded that a storm may affect the route along which a vehicle (e.g., cargo ship) is traveling, which may ultimately result in a delayed delivery at the intended destination. Taking this delivery data into account, the suggested action may include, but is not limited to, modifying the vehicle speed, modifying the vehicle route, modifying the destination location, modifying scheduled departure time for cargo, modifying mode of transit for cargo, modifying the itinerary, modifying the carrier of the mode of transit, and combinations of at least two thereof, so as to avoid the storm and improve likelihood of on-time delivery of the cargo.

Accordingly, a member of a supply chain is provided with the ability to take an active role in the decision-making process so as to maintain the delivery of cargo as intended. Accordingly, systems and methods of the invention provide a member of a supply chain with accurate and up-to-date visibility of shipment of cargo and further provide a member of a supply chain with the ability to take an active role in the handling and delivery of cargo, which can save time and money associated with delays.

Other aspects of the invention relate to systems and methods for increasing likelihood of a consumer purchasing a product. In one embodiment, a first set of data of a consumer within a retail space (e.g., store) is received from a device generally associated with the consumer. The device may be configured to transmit the first set of data. The first set of data may include, but is not limited to, location of the consumer within the retail space, movement of the consumer within the retail space, activity of the consumer within the retail space, consumer interaction with one or more products, purchase information of the consumer, identity information of the consumer, and a combination thereof. A second set of data associated with a product within the retail space is received from a device operably associated with the product. Similar to the consumer device, the product device is able to transmit the second set of data. The second set of data may include, but is not limited to, location of the product within the retail space, identity of the product, movement of the product, consumer interaction with the product, consumer interaction with a display case associated with the product, removal of the product from the retail space, and a combination thereof.

The first and second sets of data are then analyzed and consumer data is generated. In one embodiment, an output is provided to the consumer based on the consumer data, in which the output may increase the likelihood of the consumer purchasing the product. In another embodiment, the output is provided to a member of a supply chain based on the consumer data to thereby allow the member of the supply chain to make a decision that may increase likelihood of the consumer purchasing the product. For example, in one embodiment, the consumer data may indicate that the consumer is interested in a particular product due to the consumer opening a display case having that product stored within.

In one embodiment, the output, which may include, but is not limited to, product details, product promotions, product special offers, product coupons, and product inventory may be provided to the consumer by one or more delivery mechanisms so as to persuade the consumer to purchase the product. In some embodiments, the output may be delivered to the consumer by way of an audible promotion (e.g., sound file) presented on a speaker of the consumer's mobile device and/or a speaker associated with the display case. In some embodiments, the output may be delivered to the consumer by way of a video promotion presented on the consumer's mobile device display screen and/or a display screen associated with the display case within the retail space. In another embodiment, upon receiving the output, the member of the supply chain may make a decision based on the output. The decision may result in the delivery of product details, product promotions, product special offers, product coupons, and the like the one or more delivery mechanisms so as to persuade the consumer to purchase the product.

Accordingly, systems and methods of the invention provide an intuitive means of interacting with consumers to increase product awareness and marketing, thereby increasing the likelihood of product purchase.

### BRIEF DESCRIPTION OF THE DRAWINGS

FIG. 1 is a block diagram illustrating one embodiment of an exemplary system for increasing likelihood of an on-time delivery of cargo.

FIG. 2 is a plot diagram illustrating an exemplary automatic identification system (AIS) tracking service.

FIG. 3 is a block diagram illustrating collection of data from an AIS tracking service for monitoring location of AIS beacon equipped vehicles.

FIG. 4 is a block diagram illustrating a portion of the cargo tracking system of FIG. 1 in greater detail.

FIG. 5 is an enlarged view of a portion of the plot diagram of FIG. 2 illustrating the collection of additional data associated with at least one destination for the one or more vehicle carrying cargo.

FIG. 6 is a block diagram illustrating the generation of delivery data based on the analysis of various sets of data and the transmission of a suggestive action to a member of a supply chain based on the delivery data.

FIG. 7 is a block diagram illustrating one embodiment of a control system for value chain optimization consistent with the present disclosure.

FIG. 8 is a flow diagram illustrating one embodiment of a method for increasing likelihood of an on-time delivery of cargo.

FIG. 9 is a perspective exploded view of a sensor consistent with the present disclosure.

FIG. 10 is an illustration of an example scenario of monitoring transportation of cargo consistent with the present disclosure.

FIG. 11 is a schematic illustrating a retail space providing one or more products for sale and a consumer within.

FIG. 12 is a block diagram illustrating one embodiment of an exemplary system for increasing likelihood of a consumer purchasing a product.

FIG. 13 is a block diagram illustrating the generation of consumer data based on the analysis of various sets of received data and the transmission of an output to a consumer device and/or member of a supply chain based on the consumer data.

FIG. 14 and FIG. 15 are flow diagrams illustrating embodiments of methods for increasing likelihood of a consumer purchasing a product.

### DETAILED DESCRIPTION

By way of overview, the invention generally relates to systems and methods for increasing the likelihood of an on-time delivery of cargo based, at least in part, on active participation from the member of a supply chain in the shipping process. In one embodiment, a variety of different input data is received (either periodically or continuously) and analyzed by a tracking service. The different input data may be associated with the cargo, intermediate and/or final destinations of the cargo, and an object associated with the cargo.

In one aspect, a first set of data associated with one or more objects that move in space and time is received. The one or more objects that move in space and time may include, for example, a vehicle, such as a bicycle, an automobile, an aircraft, a watercraft, and/or a locomotive. However, in other embodiments, the one or more objects may include human subjects. The first set of data may include, but is not limited to, an identity of the vehicle, location of the vehicle, fuel consumption of the vehicle, environment around the vehicle, environment within the vehicle, movement of the vehicle, capacity of the vehicle, operational status of the vehicle, itinerary of the vehicle, owner of the vehicle, operator of the vehicle, and a combination thereof. A second set of data associated with one or more destinations for the cargo is also received. The second set of data may include, but is not limited to, identity of the destination, location of the destination, overall capacity of the destination, current capacity of the destination, seasonality of the destination, operational status of the destination, schedule of the destination, operator of the destination, current weather at the destination, predicted weather at the destination, current working conditions at the destination, predicted working conditions at the destination, location of one or more types of vehicles arriving at the destination, and a combination thereof.

It should be noted that, as used herein, the term “set of data” can include a single data point. Accordingly, the first and second sets of data described herein (and any other sets of data further described herein) can include a single data point and need not include a plurality of data points.

At least the first and second sets of data are analyzed and delivery data is generated. The delivery data generally relates to a scheduled delivery for the cargo. In some instances, the tracking service may allow a member of a supply chain (e.g., manufacturer of cargo) to access the service and have visibility to the delivery data. Accordingly, the member of a supply chain may be provided the most up-to-date calculation of an estimated scheduled delivery for their cargo. Furthermore, a suggested action may be provided to the member of a supply chain based on the delivery data, wherein the suggested action is intended to increase the likelihood of an on-time delivery of the cargo. For example, based on the delivery data, it may be concluded that a storm may affect the route along which a vehicle (e.g., cargo ship) is traveling, which may ultimately result in a delayed delivery at the intended destination. Taking this delivery data into account, the suggested action may include, but is not limited to, modifying the vehicle speed, modifying the vehicle route, modifying the destination location, modifying scheduled departure time for cargo, modifying mode of transit for cargo, modifying the itinerary, modifying the carrier of the mode of transit, and combinations of at least two thereof, so as to avoid the storm and improve likelihood of on-time delivery of the cargo. Accordingly, a member of a supply chain is provided with the ability to take an active role in the decision-making process so as to maintain the delivery of cargo as intended. Accordingly, systems and methods of the invention provide a member of a supply chain with accurate and up-to-date visibility of shipment of cargo and further provide a member of a supply chain with the ability to take an active role in the handling and delivery of cargo, which can save time and money associated with delays.

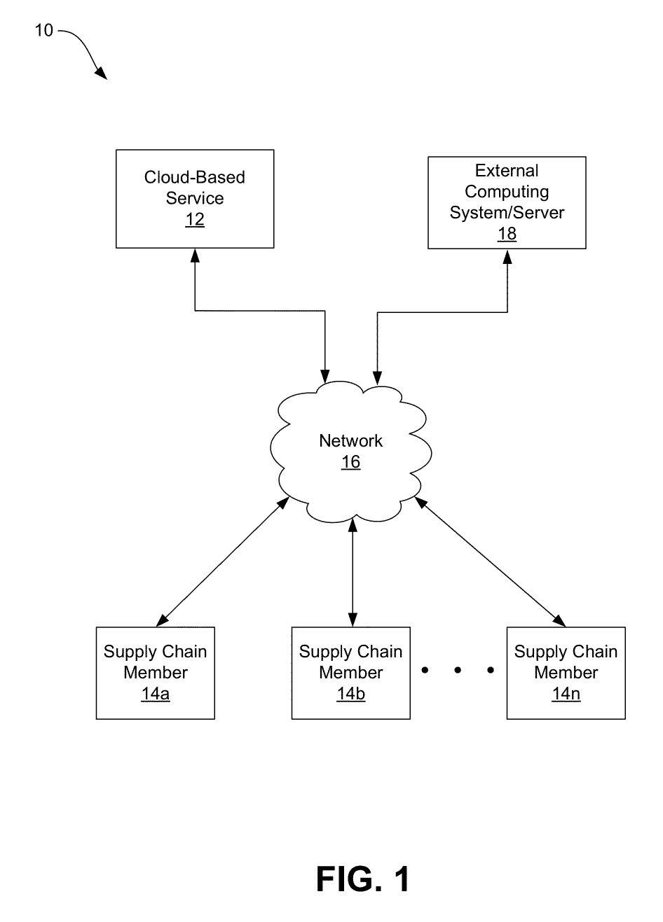

FIG. 1 is a block diagram illustrating one embodiment of an exemplary system 10 for increasing likelihood of an on-time delivery of cargo. As shown, the system 10 includes a cloud-based service 12 configured to communicate with and share data with one or more members of a supply chain (shown as member of a supply chain 14a-14n) over a network 16. In the present context, the member of a supply chain 14a-14n may include, but are not limited to, one or more members of a supply chain associated with particular cargo being shipped via a vehicle, such as, for example, a manufacturer and/or distributor of the cargo. Additionally, or alternatively, some members of a supply chain 14a-14n may include a customer to which the cargo is being delivered (e.g., single consumer, store owner, destination owner, etc.). The system 10 further includes an external computing system/server 18 configured to communicate with at least the cloud-based service 12 via the network 16. The external computing system/server 18 may be embodied as any type of system or server for communicating with the cloud-based service 12 and for performing the other functions described herein. In the embodiments described herein, the external computing system/server 18 is embodied as a centralized repository database 20 associated with the Automatic Identification System (AIS) for tracking and monitoring maritime vessel traffic.

The network 16 may be any network that carries data. Non-limiting examples of suitable networks that may be used as network 16 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), other networks capable of carrying data, and combinations thereof. In some embodiments, network 16 is chosen from the internet, at least one wireless network, at least one cellular telephone network, and combinations thereof. As such, the network 16 may include any number of additional devices, such as additional computers, routers, and switches, to facilitate communications. In some embodiments, the network 16 may be or include a single network, and in other embodiments the network 16 may be or include a collection of networks.

As described in greater detail herein, the cloud-based service 12 is configured to access and/or receive data from at least the external computing system/server 18, and, based on an analysis of such data, generate delivery data related to a scheduled delivery of cargo on one or more vehicles. The cloud-based service 12 is further configured to allow one or more members of a supply chain 14 to access the delivery data so as to have real-time visibility to the logistics of the cargo shipping process. For example, the cloud-based service 12 is configured to communicate and share data with a device associated with one or more members of a supply chain 14 (hereinafter referred to as member device). The member device may be embodied as any type of device for communicating with the cloud-based service 12 and/or other member devices over the network 16. For example, at least one of the member devices may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure.

The cloud-based service 12 is configured to continually provide output to the member device such that associated members 14 may have access to data related to the vehicle carrying their cargo and/or data associated with the destination for the cargo. For example, in some embodiments, the delivery data may be presented to a member 14 via a display operably coupled to the member device, such that the member 14 is able to have real-time visibility to the logistics of the cargo shipping process. The member device may further provide an interface for allowing a member 14 to interact with the delivery data (e.g., filter, sort, access different sets of data, etc.) and further communicate with the cloud-based service 12. The members 14 may further have access to other types of data, such as news feed data or other external sources of logistics impacting data associated with the vehicle, the destination of the cargo, and other factors that may have an effect on delivery and/or distribution of the cargo. For example, the logistics impacting data may include specific customer data (obtained by way of Enterprise Resource Planning (ERP) business management software and/or Customer Relationship Management (CRM) system) and/or third-party information that may play a role in the decision making process. For example, the news feed/logistics impacting data may include a production schedule, cost of fuel, cost of commodities, and the like.

The cloud-based service 12 is further configured to analyze the delivery data for any one of the members 14 and provide one or more suggested actions. The suggested action is generally intended to increase the likelihood of an on-time delivery of the cargo. The cloud-based service 12 is configured to provide suggested actions to the member device, wherein the suggested actions may be presented to the member 14 via the display of the member device. The member 14 may further interact with an interface displayed on the member device so as to make a decision, in real-time, as to whether to act on the suggested action or not act on the suggested action. In the event that the member makes the decision to act on the suggested action, the likelihood of an on-time delivery of the cargo may increase.

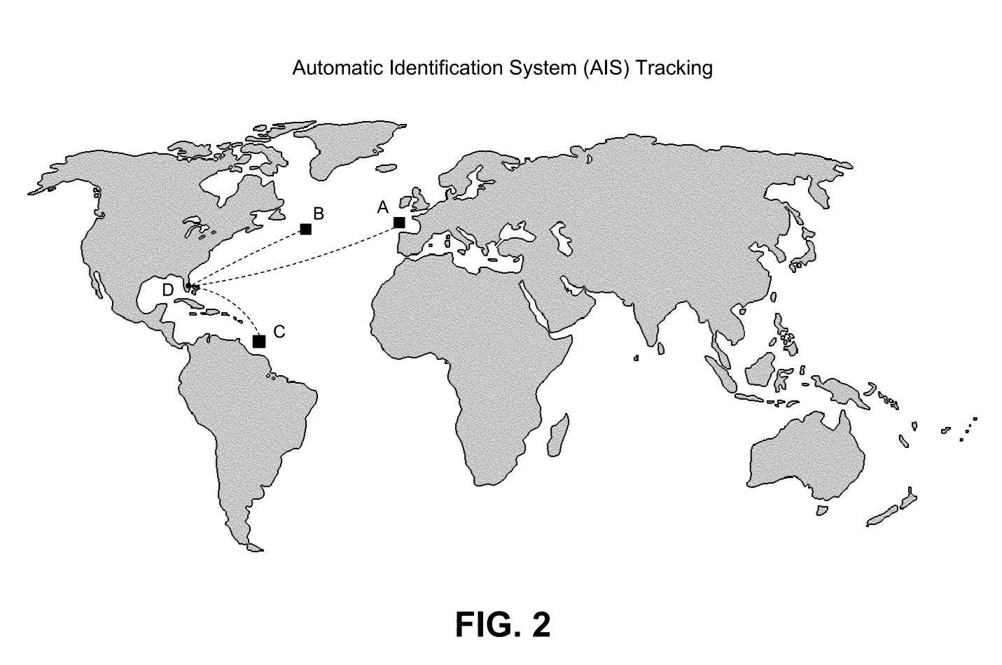

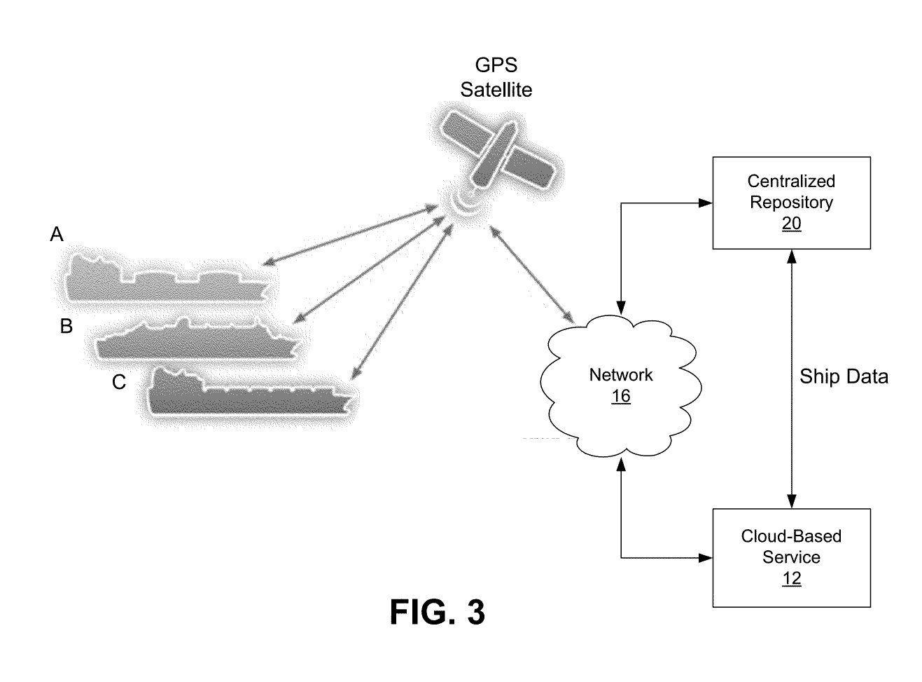

FIG. 2 is a plot diagram illustrating an exemplary automatic identification system (AIS) tracking service. FIG. 3 is a block diagram illustrating collection of data from an AIS tracking service for monitoring location of AIS beacon equipped vehicles. As previously described, the external computing system/server 18 may generally include a centralized repository database 20 associated with an AIS for tracking and monitoring maritime vessel traffic.

In this instance, one or more vehicles carrying cargo include watercraft, such as cargo freights, and the like. However, it should be noted that systems and methods of the present invention may be configured to increase the likelihood of an on-time delivery of cargo carried by other types of vehicles, including, but not limited to, a bicycle, an automobile, an aircraft, a watercraft, a locomotive, and a combination of at least two thereof. Accordingly, other types of known tracking systems may be incorporated and applicable to the present invention, such as global positioning satellite (GPS) tracking and monitoring, and the like. Typically, systems and methods of the invention can track more than one vehicle at any time.

Referring to FIG. 2, the AIS tracking system is used on ships and by vessel traffic services (VTS) for identifying and locating vessels by electronically exchanging data with other nearby ships, AIS base stations, and satellites. Information provided by AIS equipment, such as unique identification, position, course, and speed, can be displayed on a screen or an ECDIS. AIS is intended to assist a vessel's watch-standing officers and allow maritime authorities to track and monitor vessel movements. An AIS generally integrates a standardized VHF transceiver with a positioning system such as a GPS or LORAN-C receiver, with other electronic navigation sensors, such as a gyrocompass or rate of turn indicator. Vessels fitted with AIS transceivers and transponders can be tracked by AIS base stations located along coast lines or, when out of range of terrestrial networks, through a growing number of satellites that are fitted with special AIS receivers which are capable of de-conflicting a large number of signatures.

AIS transponders automatically broadcast information, such as their position, speed, and navigational status, at regular intervals via a VHF transmitter built into the transponder. The information originates from the ship's navigational sensors, typically its global navigation satellite system (GNSS) receiver and gyrocompass. Other information, such as the vessel name and VHF call sign, is programmed when installing the equipment and is also transmitted regularly. The signals are received by AIS transponders fitted on other ships or on land based systems, such as VTS systems. The received information can be displayed on a screen or chart plotter, showing the other vessels' positions in much the same manner as a radar display.

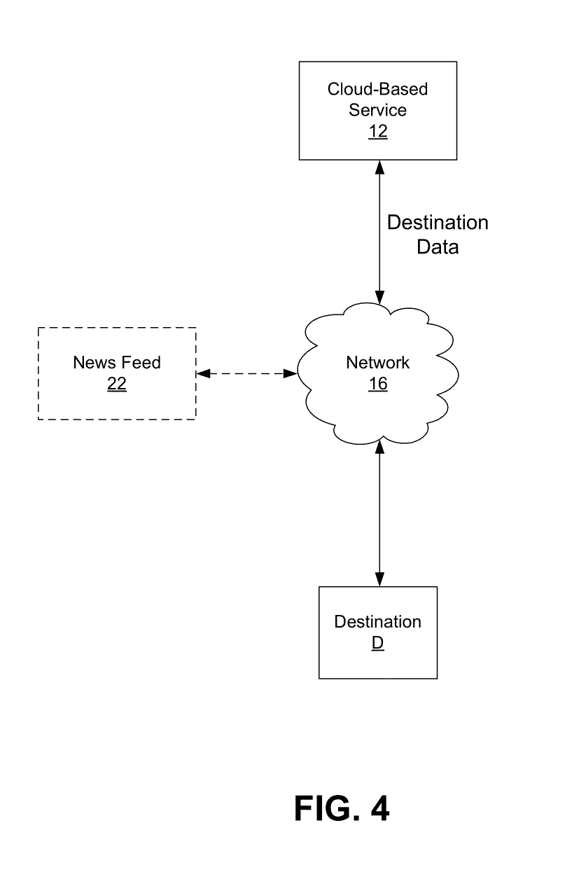

AIS data associated with ships can be stored in a centralized repository database 20 and continually updated. The cloud-based service 12 is configured to access the centralized repository database 20 and receive data associated with the ships. As shown in the plot of FIG. 2, at least three separate ships A, B, and C are currently shipping cargo to the same destination D (e.g., Miami). As shown in FIG. 3, the cloud-based service 12 is configured to access the centralized repository database 20 and receive a first set of data (e.g., ship data) associated with the one or more ships A, B, and/or C. It should be noted that a set of data, as referred to herein, can include a single data point and need not include a plurality of data points. The first set of data may include, but is not limited to, identity of the vehicle, location of the vehicle, fuel consumption of the vehicle, environment around the vehicle, environment within the vehicle, movement of the vehicle, capacity of the vehicle, operational status of the vehicle, itinerary of the vehicle, owner of the vehicle, operator of the vehicle, and a combination of at least two thereof. As shown in FIG. 4, the cloud-based service 12 is further configured to communicate with at least one of the destinations (e.g., destination D) and receive a second set of data associated with the destinations. Similar to the first set of data, the second set of data can include a single data point. The second set of data (e.g., destination data) may include, but is not limited to, identity of the destination, location of the destination, overall capacity of the destination, current capacity of the destination, seasonality of the destination, operational status of the destination, schedule of the destination, operator of the destination, current weather at the destination, predicted weather at the destination, current working conditions at the destination, predicted working conditions at the destination, location of one or more types of vehicles arriving at the destination, and a combination of at least two thereof.

In one embodiment, the cloud-based service 12 is configured to access the centralized repository database 20 and receive ship data associated with at least 30% and up to all worldwide maritime traffic, as provided by AIS tracking systems and services, at any given moment. For example, the cloud-based service 12 is configured to gain access to and analyze ship data accounting for at least 30% or more AIS beacon equipped vehicles in the water at any single point in time. Accordingly, the cloud-based service 12 is configured to provide services on a global scale. In one embodiment, the cloud-based service 12 is configured to monitor at least 35% of maritime traffic. In another embodiment, the cloud-based service 12 is configured to monitor at least 40% of maritime traffic. In another embodiment, the cloud-based service 12 is configured to monitor at least 45% of maritime traffic. In another embodiment, the cloud-based service 12 is configured to monitor at least 50% of maritime traffic. In another embodiment, the cloud-based service 12 is configured to monitor at least 55% of maritime traffic. In another embodiment, the cloud-based service 12 is configured to monitor at least 60% of maritime traffic. In another embodiment, the cloud-based service 12 is configured to monitor at least 65% of maritime traffic. In another embodiment, the cloud-based service 12 is configured to monitor at least 70% of maritime traffic. In another embodiment, the cloud-based service 12 is configured to monitor at least 75% of maritime traffic. In another embodiment, the cloud-based service 12 is configured to monitor at least 80% of maritime traffic. In another embodiment, the cloud-based service 12 is configured to monitor at least 85% of maritime traffic. In another embodiment, the cloud-based service 12 is configured to monitor at least 90% of maritime traffic. In another embodiment, the cloud-based service 12 is configured to monitor at least 95% of maritime traffic. In another embodiment, the cloud-based service 12 is configured to monitor at least 100% of maritime traffic.

Referring to FIG. 4, the cloud-based service 12 may be further configured to receive at least a third set of data, generally in the form of a news feed 22, which may include current news related to the cargo itself, the ship, and/or the destination. For example, the news feed 22 may provide news related to current inventory statistics of the cargo, which may have an effect on the delivery of the cargo, or the destination to which the cargo should be delivered. The news feed 22 may also include other external sources of logistics impacting data, which may include specific customer data (obtained by way of Enterprise Resource Planning (ERP) business management software and/or Customer Relationship Management (CRM) system) and/or third-party information that may play a role in the decision making process. For example, the news feed/logistics impacting data may include a production schedule, cost of fuel, cost of commodities, and the like.

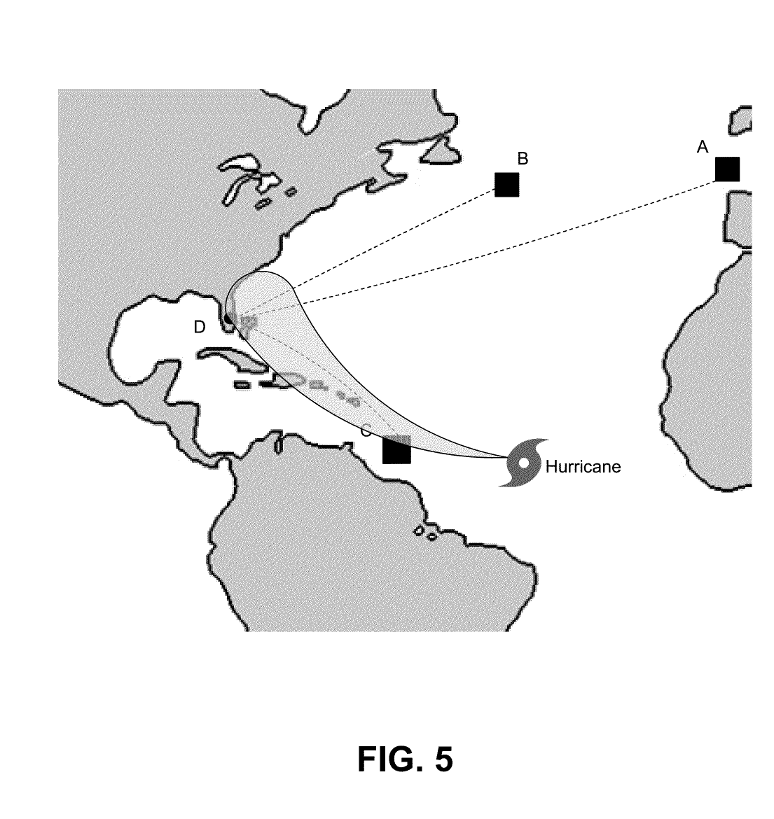

FIG. 5 is an enlarged view of a portion of the plot diagram of FIG. 2 illustrating the collection of additional data associated with at least one destination D for the one or more vehicles A, B, and C carrying cargo. For example, the first set of data may include a predicted path of a hurricane within the region that the ships A, B, and C are traveling. Accordingly, the cloud-based service 12 is configured to take this weather-related data into account when analyzing the first and second sets of data and generating delivery data.

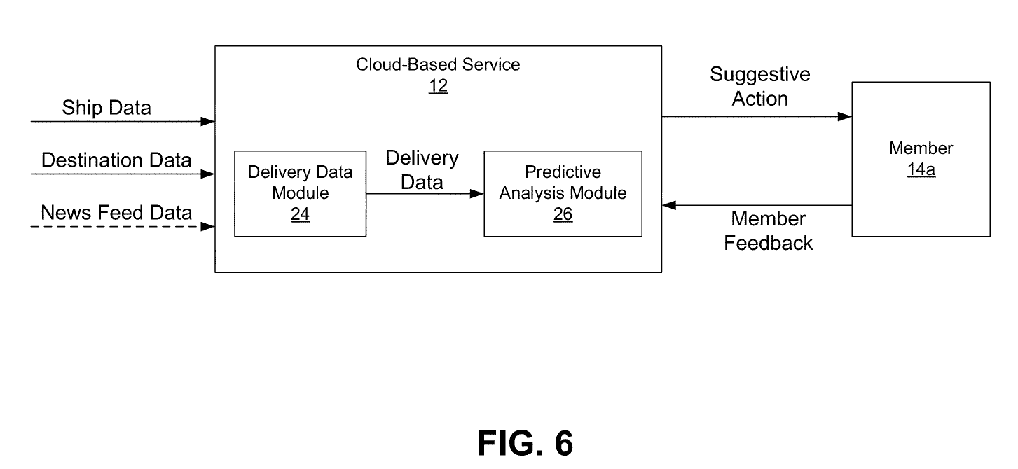

FIG. 6 is a block diagram illustrating the generation of delivery data based on the analysis of various sets of data and the transmission of a suggestive action to a member of a supply chain based on the delivery data. As shown, the cloud-based service 12 may include a delivery data module 24 configured to receive at least the first and second sets of data (e.g., ship data and destination data), and generate delivery data related to the scheduled delivery for the cargo. The delivery data module 24 may include custom, proprietary, known and/or after-developed statistical analysis code (or instruction sets), hardware, and/or firmware that are generally well-defined and operable to receive one or more sets of data and identify, at least to a certain extent, a pattern related to an accurately estimated delivery time.

In some embodiments, the processing of at least the first and second sets of data may include geospatial indexing based off of linear data, thereby resulting in increased speed of computations and improving real-time transmission of data. For example, the spatial indices used by systems and methods of the present invention optimize spatial queries. In some embodiments, a quadtree spatial indexing method is used, such that, in the case the world map, as shown in FIG. 2, the map is recursively subdivided into four quadrants or regions. The regions may be square or rectangular, or may have arbitrary shapes. Data is then encoded into the quad indices, which further allows other known statistical pattern recognition methods to be used, including, for example, clustering analysis.

It should be noted that the cloud-based service is configured to receive at least the first and second sets of data (ship data and destination data) in real-time and at least at one point in time during the transportation of the cargo. Additionally, or alternatively, the cloud-based service is configured to receive the first and second sets of data in real-time and at least at two different points in time, so as to continuously generate accurate delivery data throughout the course of the cargo transport.

The cloud-based service 12 may further include a predictive analysis module 26 configured to receive the delivery data and generate a suggestive action to transmit to a member of a supply chain 14. The predictive analysis module 26 may include custom, proprietary, known and/or after-developed statistical analysis code (or instruction sets), hardware, and/or firmware that are generally well-defined and operable to receive delivery data and identify, at least to a certain extent, a suggested course of action based on the delivery data. The suggested action is intended to increase the likelihood of an on-time delivery of the cargo. For example, as shown in FIG. 5, it may be concluded that a storm may affect the route along which at least ship C is traveling, which may ultimately result in a delayed delivery at the intended destination D. Taking this delivery data into account, the suggested action may include, but is not limited to, modifying the vehicle speed, modifying the vehicle route, modifying the destination location, modifying scheduled departure time for cargo, modifying mode of transit for cargo, modifying the itinerary, modifying the carrier of the mode of transit, and combinations of at least two thereof, so as to avoid the storm and improve likelihood of on-time delivery of the cargo.

As previously described herein, the cloud-based service 12 is configured to continually provide the generated delivery data and suggestion actions to a device associated with one or more members of a supply chain 14 (e.g. a member device). More specifically, the delivery data and/or suggested actions may be presented to a member 14 via a display operably coupled to the member device, such that the member 14 is able to have real-time visibility to the logistics of the cargo shipping process. The member 14 can then utilize an interface provided on the display allowing a member to interact with the delivery data (e.g., filter, sort, access different sets of data, etc.), as well as make a decision, in real-time, as to whether to act on the suggested action or not act on a suggested action. Accordingly, a member of a supply chain is provided with the ability to take an active role in the decision-making process so as to maintain the delivery of cargo as intended.

Accordingly, systems and methods of the invention provide a member of a supply chain with accurate and up-to-date visibility of shipment of cargo and further provide the member with the ability to take an active role in the handling and delivery of cargo, which can save time and money associated with delays.

In one embodiment, an exemplary algorithm for analyzing the combination of at least the first and second data sets, for generating delivery data, and further optionally providing predictive analysis and suggestive actions based on the delivery data, involves a three-layer intelligence platform. The three-layer intelligence platform analyzes on an individual shipment level, transit company level, and network level. The algorithm runs numerous simulations to determine the most likely outcome (e.g., delivery data) and then provides that delivery data to one or more members of the supply chain.

Exemplary classes of algorithms that can be used to analyze the incoming first and second sets of data (as well as additional sets of data) include, but are not limited to, Classification, Clustering, Regression, and Dimensionality Reduction. In one example, a prediction could be made with regard to fuel efficiency of any given vessel based on linear or polynomial regression. Additionally, or alternatively, k-means clustering can be used to identify discrete groups within the received data, wherein such discrete groups could then be classified against (e.g., vessel categorization and classification). The algorithms can be run either using stream processing or batch processing, and, depending on what the desired runtime performance and memory constraints are, different layers of computation can be mixed and matched using different processing heuristics. The system is configured to heavily draw upon tallying and take-the best heuristics when environment variance is too high (approach derived from the bias-variance dilemma.

The cloud-based service 12 may be configured to analyze the first and second sets of data, generate at least the delivery data, and optionally provide suggestive actions to a member of a supply chain based on the delivery data, based on a fusion of at least three domains, including: 1) agent-based modeling (ABM) for graphical information systems (GIS); 2) Ant-Based Control (ABC); and 3) probabilistic graphical modeling techniques.

Agent-based modeling (ABM) includes a class of computational models for simulating the actions and interactions of autonomous agents (both individual and collective entities such as organizations or groups) with a view to assessing their effects on the system as a whole. ABM may combine elements of game theory, complex systems, emergence, computational sociology, multi-agent systems, and evolutionary programming. Monte Carlo Methods are used to introduce randomness. Graphical information systems (GIS) may include applications which involve the use of a combination of digital maps and georeferenced data. For more information on ABM, see Johnston, Kevin et al., Agent Analyst: Agent-Based Modeling in ArcGIS, First Edition, 2013, Esri Press, New York; Heppenstall, A. J. et al., Agent-Based Models of Geographical Systems, 2012, Springer, New York; and Cooks, Andrew, “New Paper: Assessing the impact of demographic characteristics on spatial error in VGI features”, Web blog post, gisagents.org, 9 Jul. 2014 (accessed 7 Aug. 2014).

Ant-Based Control (ABC) generally includes the use of an ant colony optimization (ACO) algorithm, which is a probabilistic technique for solving computational problems which can be reduced to finding improved paths through the use of graphs. For example, ABC routing algorithms have been used in some dynamic routing systems, in which vehicles (e.g., cars) are tracked in a city and can be rerouted based on the computation of the shortest traveling time from a starting point to a destination based on ABC algorithms. For more information on Ant-Based Control, see Tatomir, Bogdan et al., Travel Time Prediction for Dynamic Routing Using Ant Based Control, Proceedings of the 2009 Winter Simulation Conference, Delft University of Technology, Netherlands, 2009; Suson, Adriana, Dynamic Routing using Ant-Based Control, Delft University of Technology, Netherlands, 2010; Claes, Rutger et al., Ant Colony Optimization applied to Route Planning using Link Travel Time predictions, 2011 IEEE International Parallel & Distributed Processing Symposium, IEE Computer Society, 2011; and Burrows, Philip et al., Efficient Traffic Routing using ACO, University of Birmingham, http://www.cs.bham.ac.uk/˜rjh/courses/NatureInspiredDesign/2011-12/CourseWork/Group5.pdf, 2012.

Probabilistic graphical models generally use a graph-based representation as the foundation for encoding a complete distribution over a multi-dimensional space and a graph that is a compact or factorized representation of a set of independences that hold in the specific distribution. This type of modeling technique may generally be used in probability theory, statistics—particularly Bayesian statistics—and machine learning. For more information on probabilistic graphical modeling systems and techniques, see Hofleitner, Aude et al., Arterial travel time forecast with streaming data: A hybrid approach of flow modeling and machine learning, Elsevier, Volume 46, Issue 9, November 2012, Pages 1097-1122; van Hinsbergen, Chris et al., Bayesian Calibration of Car-Following Models, 12th IFAC Symposium on Transportation Systems, Department of Transport and Planning, Faculty of Civil Engineering and Geosciences, Delft University of Technology, Netherlands, 2009; van Hinsbergen, Chris, Bayesian data assimilation for improved modeling of road traffic, Netherlands Research School for Transport, Infrastructure and Logistics, Volumes 2010-2019 of TRAIL thesis series, Netherlands, 2010; van Hinsbergen, Chris et al., Bayesian Combination of Travel Time Prediction Models, Transportation Research Record: Journal of the Transportation Research Board, Volume 2064/2008 Information Systems, Geographic Information Systems, and Advanced Computing, pages 73-80, Transportation Research Board of the National Academies, 2008; van Hinsbergen, Chris et al., Bayesian committee of neural networks to predict travel times with confidence intervals, Transportation Research Part C 17,498-509, Elsevier, 2009; and Si, Liuxin, Bayesian Network Applications for Traffic Prediction and Traffic Loads in Bridges in the Netherlands, Delft University of Technology, 2012.

In one example, cloud-based service 12 may include a real-time AI system including a combination of machine and human intelligence for analyzing incoming data sets, generating delivery data, and providing predictive analysis based on the delivery data, including suggestive actions to a member of a supply chain. The AI system may include a “brain” developed based on anomaly detection software and machine learning algorithms. Examples of such anomaly detection software and/or machine learning algorithms include GROK, a machine-learning system providing automated predictive modeling and NuPIC, an open-source platform for intelligent computing that is compatible with GROK. Both GROK and NuPIC are offered by Numenta (Redwood City, Calif.). NuPIC provides code for a neocortical model identified as “Cortical Learning Algorithm” (CLA). For more information on the CLA, see Hierarchical Temporal Memory including HTM Cortical Learning Algorithms, Version 0.2.1., http://www.numenta.com/assets/pdf/whitepapers/hierarchical-temporal-memory-cortical-learning-algorithm-0.2.1-en.pdf, Numenta, 2011.

The real-time AI system may further include the use of software agents configured to cooperate with the “brain”, as well as other agents, so as to provide solutions to logistic problems in real-time. As generally understood, a software agent is a computer program that acts for a user or other program in a relationship of agency. The software agents may include, but are not limited to, intelligent agents (exhibit some aspect of artificial intelligence, such as learning and reasoning), autonomous agents (capable of modifying the way in which they achieve their objectives), distributed agents (executed on physically distinct computers), multi-agent systems (distributed agents that do not have the capabilities to achieve an objective alone and thus must communicate), mobile agents (agents that can relocate their execution onto different processors), and hybrids of two or more of the different types.

The real-time AI system generally functions based on the concept of layers. For example, a first layer includes data, wherein all incoming/outgoing data is as current and up-to-date as possible, such that the max delay between refreshed data is less than 5 to 15 minutes. Accordingly, the system is configured to continually update all information related to transportation and delivery of the cargo. A second layer includes semantics. Generally, all received data is organized into semantics, such that data associated with cargo is converted into real-time into semantic information and low-level reasoning is implement in order to convert such information into real-time. For example, software agents can be implemented to collected data and convert such data into semantic information, which can then be provided to the “brain”.

In one embodiment, the system may incorporate a multi-agent system, including autonomous agents embedded into devices (e.g., sensors) associated with the one or more vehicles (e.g., ships) and/or the destination(s) to which the cargo is being delivered and intelligent agents configured to emulate shipment transportation and to continually compute the likelihood of delivery and delivery delay. The system may further include emulation systems configured to provide a semantically and operationally enriched map to visualize predictions, possible problems and bottlenecks, and work-around. An agent-manager may be configured to monitor the functionality of the agents (autonomous or intelligent agents) and further create/delete agents as necessary. For example, an agent-manager may create a new agent for any new shipment and associated device, and constantly monitor the new agent. In the event that the new agent is not functioning correctly, this manager kills it and creates another.

An agent is configured to receive data from the device and immediately transforms it into information (e.g., based on web ontology language (OWL)) about the shipment. There are other agents responsible for receiving data about the shipment from other streams. Based on business rules, an agent is configured to send an instruction to a device on how often the device should send data. If not programmed with such an instruction, the device can function according to a default schedule. Additionally, if communication is lost between a device and an agent, and not restored in a sufficient time, the agent is configured to send an alert to the agent's manager, in which the agent-manager is configured to re-send it to the queue of lost connections.

All semantic information is transmitted from agents to the “brain”, wherein the “brain” is configured to automatically build/re-build/update an increasingly more sophisticated model for each shipment and, based on the model, the “brain” is configured to take one or more actions, including command agents, modify business rules, communicate with humans, etc. For example, upon receiving the semantic information, the AI system is further configured to Calculate current distances from destinations and compute potential problems based on data mining (similarities in historical data), verify these predictions by simulation using business rules, and visualize problems and possible bottlenecks on a semantically and operationally enriched map (e.g., based on Google map). Accordingly, the system can generate delivery data for any one vehicle.

The system is further configured to provide predictive analysis based on the delivery data, which may include determining acceptable solutions for a problem using mining of historical data, simulations (a multi-agent system) and optimization (evolutionary algorithms, ant colony optimization, particle swarm optimization, neural networks, artificial immune systems, and their hybrids). The solutions may then be provided as a suggested action to a member of a supply chain for allowing the member to make a decision based on the suggested action that may increase the likelihood of an on-time delivery of the shipment.

The AI system may further include Have an operations room including human intelligence to cooperate with the AI of the system. For example, the system is configured to communicate in a symmetrical way with personnel (e.g., via plain English) and is further configured to assist the human personnel in solving problems. The human personnel may be tasked with formulating new business rules and ways to improve the system. The system which is intelligent and able to communicate in a symmetrical way with people via plain English (voice) to gather all parties, help them to solve logistic problems and reason its recommendations.

For example, a software agent is configured to periodically provide semantic information about the shipment on a blackboard (virtual) to make it available for other agents and/or the human personnel. One of specialized agents is configured to compute prediction for a shipment as being on-time or late, the probability of the delivery time, and reasoning for human personnel (using a probabilistic graphical model). If it is determined that the shipment is going to be late, the agent is configured to send an alert to its manager, such that the agent-manager can re-send the alert to a queue of delays (the priority of the message in the queue is computed based on delay and its probability), or directly on console/map and initialize a dialog with human personnel. Based on a number of active agents, the agent-manager is configured to create/delete specialized agents so as to optimize computational resources. In this manner, the system is configured to plan an improved logistics solution for the future, compare it with existing ones, and reason based on probabilistic graphical models (Bayesian Network, Markov Random Field, Conditional Random Field, Restricted Boltzmann Machine, etc.).

The cloud-based service 12 is further configured to receive a fourth set of data in the form of feedback from the member of the supply chain as to whether a member of the supply chain acted on the suggested action. In some embodiments, the cloud-based service 12 is configured to receive and include the fourth set of data with at least the first and second sets of data during an analysis thereof, thereby improving generation of the delivery data and subsequent generation of the suggested action.

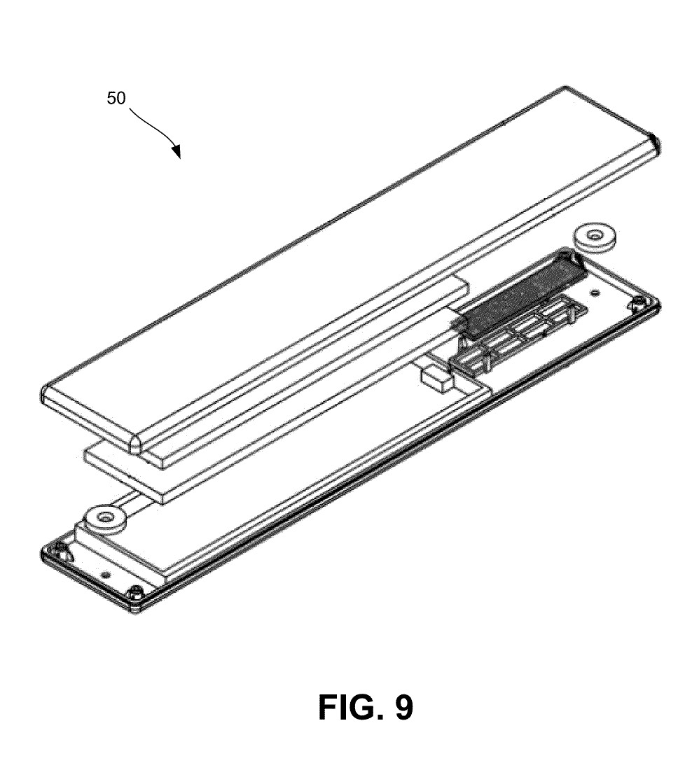

The cloud-based service 12 may further be configured to receive additional sets of data, such as a fifth set of data associated with cargo and/or the container in which the cargo is being transported. For example, as described in greater detail herein, the present invention further provides a sensor (sensor 50 shown in FIG. 9) configured to be coupled at least to a container (e.g., shipping container, freight container, etc.) and wirelessly transmit environmental data associated with the container and/or the cargo. The environmental data may include, but is not limited to, temperature, humidity, light, movement, acceleration, orientation, and the like. The environmental data may provide a member of a supply chain with an additional level of detail regarding the specific environmental factors of the cargo.

In some embodiments, the cloud-based service 12 is compatible with current business management systems and/or software that may be used by companies, distributors, and the like. For example, in some embodiments, the cloud-based service 12 is compatible with Enterprise Resource Planning (ERP) business management software and/or Customer Relationship Management (CRM) systems. As such, the cloud-based software 12 is configured to generate reports, alerts, and further transmit data to members of a supply chain by way of currently implemented ERP and/or CRM systems or software, thereby providing a seamless integration of tracking services provided by the cloud-based service with management software and systems already in use.

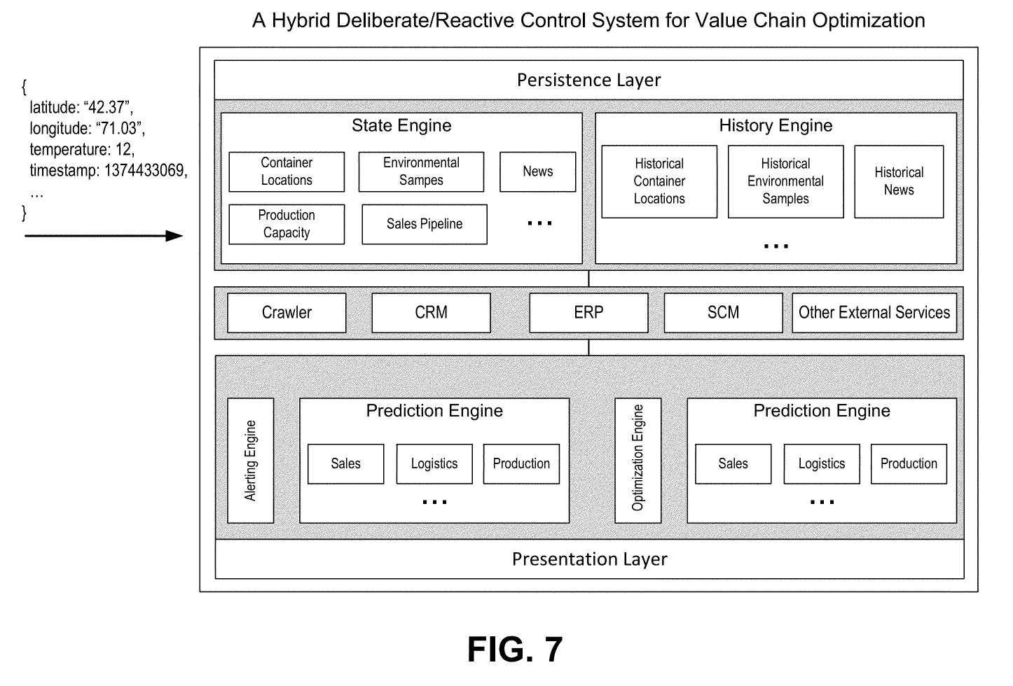

FIG. 7 is a block diagram illustrating an exemplary embodiment of a deliberate/reactive control system for value chain optimization using the real-time AI system described herein. For example, from a high level, by bridging the gap in communication between logistics/production and sales, the information gather from one side (logistics) can have an impact on the planning for the other side (production). Below are examples in which predictive analysis is used to provide suggestive actions to one or more members of a supply chain so as to allow the one or more members to make a decision that can result in optimizing the value.

In one example, it may be determined that a shipment of shampoo will have a high probability of having a large amount of spoilage before it arrives (all of a sudden, temperature dropped somewhere along the lines). Accordingly, based on such information, production can be alerted and the production of more shampoo can be ramped up. Furthermore, the sales representative can be alerted about this so that they may act accordingly. In another example, Japan and Korea both purchase Widget X and for the past 4 months Japan has been ordering 90,000 units. Generally, it would be expected that Japan would order another 90,000 units in any current month. However, for some reason, Japan decides not to order their usual unit amount. Accordingly, production would be alerted in real-time, and manufacturing of Widget X would stop, a portion of which could then be sold to Korea. Theoretically, neither Korea nor Japan could purchase Widget X for 6 months but eventually the product will spoil, so the system could inform the sales teams to figure out some way to remove the excess capacity.

In another example, the system is configured to predict the best possible shipping paths based, not on distance, but on overall cost and other external influences like political turmoil. In another example, incoming information may provide an indication that a certain portion of transit is becoming unstable, such that it may be optimal to sell less product to one customer due to impending logistics pipeline failure and instead sell that customer's product to someone else. Additionally, or alternatively, it may be determined that the customer's product be rerouted. In another example, it if is determined that a product won't spoil, but will degrade at certain temperatures, the system is configured to ensure that the carriers are aware of it and take the proper precautions. For example, consider the Northeast United States, shipping chemicals from Kentucky to Maine in the month of December. Such shipping of a chemical during this time of year may have an impact on the quality on some products (chemicals), which may need to sit in a hot room for a while until the properties of the chemicals return to their expected behavior. In another example, assume the system can successfully predict the periodicity of the global shipping markets. Accordingly, the system may be configured to tailor a client's sales cycles to take advantage of that knowledge. In another example, the system may be configured to review the historical data, and, based on the current data and historical data, project how much more a client could sell to a single customer as well as who other potential customers could be.

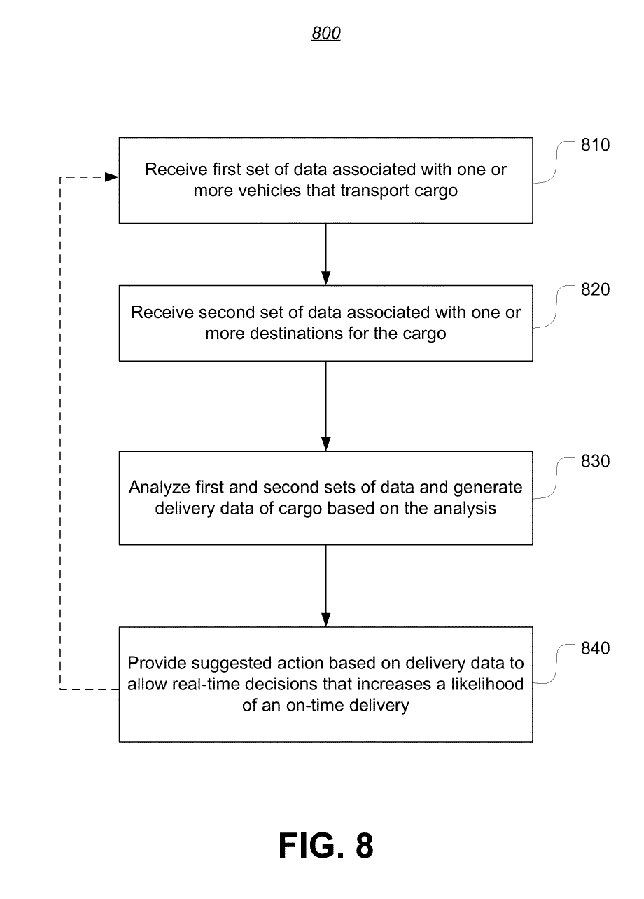

FIG. 8 is a flow diagram of a method 800 for increasing likelihood of an on-time delivery of cargo. The method 800 includes receiving a first set of data associated with one or more vehicles that transport cargo (operation 810). The first set of data includes, but is not limited to, an identity of the vehicle, location of the vehicle, fuel consumption of the vehicle, environment around the vehicle, environment within the vehicle, movement of the vehicle, capacity of the vehicle, operational status of the vehicle, itinerary of the vehicle, owner of the vehicle, operator of the vehicle, and a combination of at least two thereof. The vehicles may include, but are not limited to, a bicycle, an automobile, an aircraft, a watercraft, a locomotive, and a combination of at least two thereof. The method 800 further includes receiving a second set of data associated with one or more destinations for the cargo (operation 820). The second data may include, but is not limited to, identity of the destination, location of the destination, overall capacity of the destination, current capacity of the destination, seasonality of the destination, operational status of the destination, schedule of the destination, operator of the destination, current weather at the destination, predicted weather at the destination, current working conditions at the destination, predicted working conditions at the destination, location of one or more types of vehicles arriving at the destination, and a combination of at least two thereof.

The method 800 further includes analyzing the first and second sets of data and generating delivery data of cargo based on the analysis (operation 830). The method 800 further includes providing a suggestion action based on the delivery data to allow a real-time decision that increases a likelihood of an on-time delivery of the cargo (operation 840). The suggested action may be provided to a member of a supply chain. In one embodiment, the suggested action may be provided to a device associated with a member (e.g., member device) configured to present the suggested action to the member via a display and further allow the member to interact with an interface on the device for choosing whether to act on the suggested action. The suggested action may include, but is not limited to, modifying the vehicle speed, modifying the vehicle route, modifying the destination location, modifying scheduled departure time for cargo, modifying mode of transit for cargo, modifying the itinerary, modifying the carrier of the mode of transit, and combinations of at least two thereof.

While FIG. 8 illustrates method operations according various embodiments, it is to be understood that in any embodiment not all of these operations are necessary. Indeed, it is fully contemplated herein that in other embodiments of the present disclosure, the operations depicted in FIG. 8 may be combined in a manner not specifically shown in any of the drawings, but still fully consistent with the present disclosure. Thus, claims directed to features and/or operations that are not exactly shown in one drawing are deemed within the scope and content of the present disclosure.

It should be noted that systems and methods consistent with the present disclosure may be applicable for spot market purposes. For example, the cloud-based service 12 may be configured to analyze data and allow active participation from the member of a supply chain in the shipping process for delivery to an individual store, rather than an initial delivery destination. With regard to the shipping example described above, the initial destination of cargo may be a port in Miami, Fla., while the final destination may be numerous retail stores over a region of the country. The systems and methods of the present invention can be used to determine and/or predict product demand at any given store within the region for delivery based on continual analysis of specific sets of data associated with the product, the container in which the product is shipped, the vehicle transporting the product, the store at which the product is sold, and combinations thereof. For example, the cloud-based service 12 may gather from any given individual store, such that the stores are treated as destinations. Accordingly, data may include an identity of the store, location of the store, current inventory of a product at the store, overall capacity for the product at the store, current weather at the store, and a combination thereof. The cloud-based service 12 is configured to combine the individual store data with data associated with transportation vehicle, including identity of the vehicle, location of the vehicle, movement of the vehicle, capacity of the vehicle, operational status of the vehicle, itinerary of the vehicle, owner of the vehicle, operator of the vehicle, and a combination thereof. Based on an analysis of the combined data, the cloud-based service 12 is configured to provide a member of a supply chain with a suggested course of action for spot market purposes.

For example, an individual store in one city (e.g., Chicago) may have a given inventory of bottled water at a given point in time. However, received data suggests that there will be a heat-wave over the next few days in Chicago. In another store located in a different city (e.g., Louisville), received data suggests that the weather will be unusually cool over the next few days. Accordingly, the cloud-based service 12 is configured to analyze the data and recognize that bottles of water originally scheduled for Louisville should be rerouted for delivery to Chicago, based at least on the fact that demand for the bottled water will likely increase due, in part, to the warmer temperatures.

The present invention further provides a sensor configured to be coupled to a vehicle (e.g., bicycle, automobile, aircraft, watercraft, locomotive, etc.) or a container (e.g., shipping container, freight container, etc.) and wirelessly transmit environmental data associated with the vehicle and/or container and related to the cargo. FIG. 9 is an exploded perspective view of a sensor 50 consistent with the present disclosure. The sensor 50 may include at least one or more sensing devices configured to monitor environmental conditions. For example, the sensor 50 may include sensors configured to detect temperature, humidity, light, movement, acceleration, orientation, and the like. Accordingly, the sensor 50 may include a temperature sensor, humidity sensor, accelerometer, gyroscope, and other sensing devices. Additionally, the sensor 50 includes hardware configured to allow wireless communication via known wireless transmission protocols. For example, in one embodiment, the sensor 50 may include hardware configured to allow the sensor 50 to wirelessly communicate over any known cellular network (e.g., 2G, 3G, 4G networks). Additionally, the sensor 50 may include a GPS device for transmitting the location of the sensor 50. The sensor 50 may further include a rechargeable battery (e.g., Lithium Ion) configured to operate in a low power setting so as to provide a relatively long operating life between charges (e.g., at least 3 months). The sensor 50 further includes a durable outer case configured to withstand environmental factors, particularly those encountered in the shipping industry.

In one embodiment, the sensor 50 is configured to be placed in any cargo container and monitor the environmental conditions within the cargo container to which it is coupled. The sensor 50 is further configured to transmit the environmental data for analysis. For example, the sensor may be configured to communicate with the cloud-based service 12 described herein, such that, in addition, or alternatively, to the first and second sets of data (e.g., ship data and destination data), the environmental data of a specific container holding the cargo of interest can be received and analyzed to generate the delivery data. The environmental data may provide a member of a supply chain with an additional level of detail regarding the specific environmental factors of the cargo. For example, certain types of cargo can be particularly sensitive to temperature, humidity, excessive movement, radical changes in orientation, and the like. Accordingly, by further factoring in the environmental data into the generation of the delivery data, a more robust suggested corrective action can be provided.

In one illustrative example, the cargo may include produce, such as a shipment of bananas. Bananas may be particularly vulnerable to decomposition at a certain temperature and/or humidity. In the event that the temperature/humidity falls outside of a desired range (as determined by the member of the supply chain), the cloud-based service 12 may be configured to provide an alert to the member and further provide a suggested course of action (e.g., cancel delivery, adjust route and destination, etc.). The sensor may further be adjustable, in real-time, with regard to certain properties, such as specific parameters of the environmental conditions to be sensed, the battery life of the sensor, and on/off cycling of the sensor.

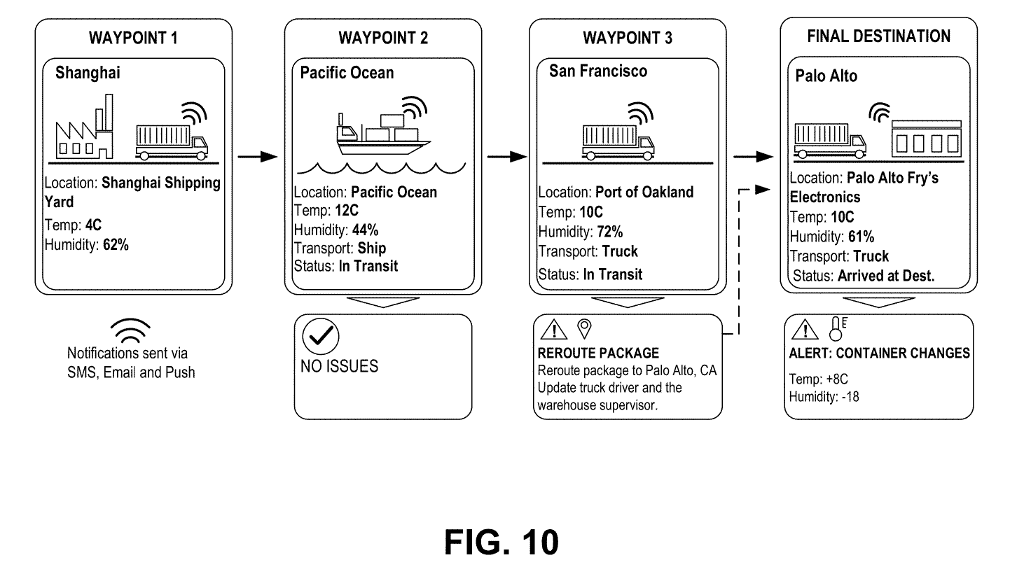

FIG. 10 is an illustration of an example scenario of monitoring transportation of cargo consistent with the present disclosure. As shown, a planned itinerary for cargo includes a point of origin of Shanghai and a destination of Palo Alto, Calif. The cloud-based service 12 described herein is configured to receive sets of data related to the cargo, the vehicle(s) transporting the cargo, and/or the destination(s) of the cargo. During the transportation of the cargo, the cloud-based service 12 is configured to continually receive sets of data and generate delivery data for output to one or more members of a supply chain. For example, the cloud-based service 12 is configured to continually generate reports for different checkpoints (or waypoints) during the cargo's travel and provide those reports to a member of the supply chain (e.g., reports presented on display operably coupled to a member device). At any given waypoint, a report may include the location of the cargo and/or vehicle transporting the cargo, the method of transportation, the status of the transportation, as well as environmental conditions. In some instances, the cloud-based service 12 may determine that one or more defined parameters of the shipment may be affected due to one or more issues (e.g., weather-related, bottleneck of shipment route, etc.). For example, the cargo may be particularly fragile and unstable in temperatures and/or humidity falling outside of a desired range. Accordingly, the cloud-based service 12 is configured to monitor the cargo and identify when such issues arise and provide an alert to the member device so as to alert the member of current unacceptable conditions. The cloud-based service 12 is further configured to provide a suggested action so as to address the issue(s). In the illustrated example of FIG. 10, the cloud-based service 12 identified that the humidity surrounding the cargo increased above a tolerant level and provided a member with an alert, which also included a suggested action (e.g., reroute delivery of package to a new destination).

The invention further provides systems and methods for increasing likelihood of a consumer purchasing a product. In one embodiment, a first set of data of a consumer within a retail space (e.g., store) is received from a device generally associated with the consumer. The device may be configured to transmit the first set of data. The first set of data may include, but is not limited to, location of the consumer within the retail space, movement of the consumer within the retail space, activity of the consumer within the retail space, consumer interaction with one or more products, purchase information of the consumer, identity information of the consumer, and a combination thereof. A second set of data associated with a product within the retail space is received from a device operably associated with the product. Similar to the consumer device, the product device is able to transmit the second set of data. The second set of data may include, but is not limited to, location of the product within the retail space, identity of the product, movement of the product, consumer interaction with the product, consumer interaction with a display case associated with the product, removal of the product from the retail space, and a combination thereof.

The first and second sets of data then analyzed and consumer data is generated. In one embodiment, an output is provided to the consumer based on the consumer data, wherein the output may increases the likelihood of the consumer purchasing the product. In another embodiment, the output is provided to a member of a supply chain based on the consumer data to thereby allow the member of the supply chain to make a decision that may increase likelihood of the consumer purchasing the product. For example, in one embodiment, the consumer data may indicate that the consumer is interested in a particular product due to the consumer opening a display case having that product stored within.

In one embodiment, the output may include, but is not limited to, product details, product promotions, product special offers, product coupons, and product inventory. The output may be provided to the consumer by one or more delivery mechanisms so as to persuade the consumer to purchase the product. In some embodiments, the output may be delivered to the consumer by way of an audible promotion (e.g., sound file) presented on a speaker of the consumer's mobile device and/or a speaker associated with the display case. In some embodiments, the output may be delivered to the consumer by way of a video promotion presented on the consumer's mobile device display screen and/or a display screen associated with the display case within the retail space. In another embodiment, upon receiving the output, the member of the supply chain may make a decision based on the output. The decision may result in the delivery of product details, product promotions, product special offers, product coupons, and the like the one or more delivery mechanisms so as to persuade the consumer to purchase the product. Accordingly, systems and methods of the invention provide an intuitive means of interacting with consumers to increase product awareness and marketing, thereby increasing the likelihood of product purchase.

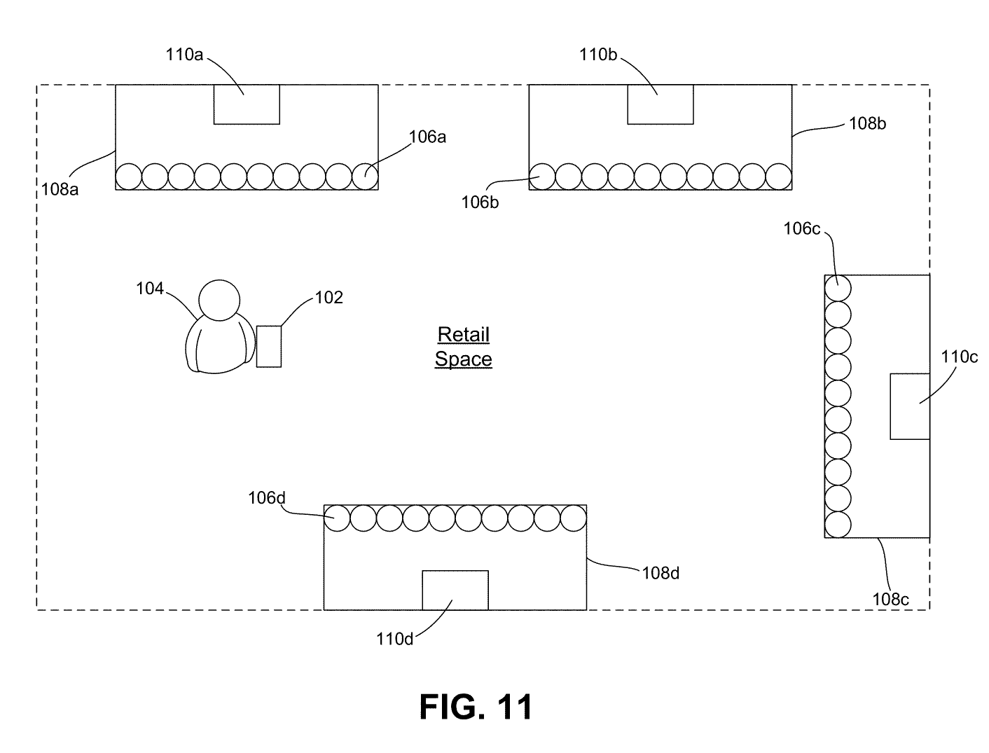

FIG. 11 is a schematic illustrating a retail space providing one or more products for sale and a consumer within. The retail space may include any space for selling goods and/or products. For example, in one embodiment, the retail space may include a beverage store offering beverages for sale. As shown, the consumer may have a device 102 configured to transmit data associated with the consumer (e.g., a first set of data), as described in greater detail herein. The retail space may include one or more products (106a-106d) provided on corresponding display cases (108a-108d). The retail space may further include one or more devices (110a-110d) associated with at least the one or more products 106. In the illustrated embodiment, the devices 110 may be operably coupled to the display cases 108. The devices 110 may be configured to transmit data associated with one or more products 106 (e.g., a second set of data). As described in greater detail herein, the first and second sets of data may be analyzed to generate information about the consumer 104, including the consumer's possible level of interest in a particular product 106. The consumer information may be used to deliver particular advertisements or promotions to the consumer 104 in real-time so as to increase the likelihood that the consumer purchases a product 106 while in the retail space.

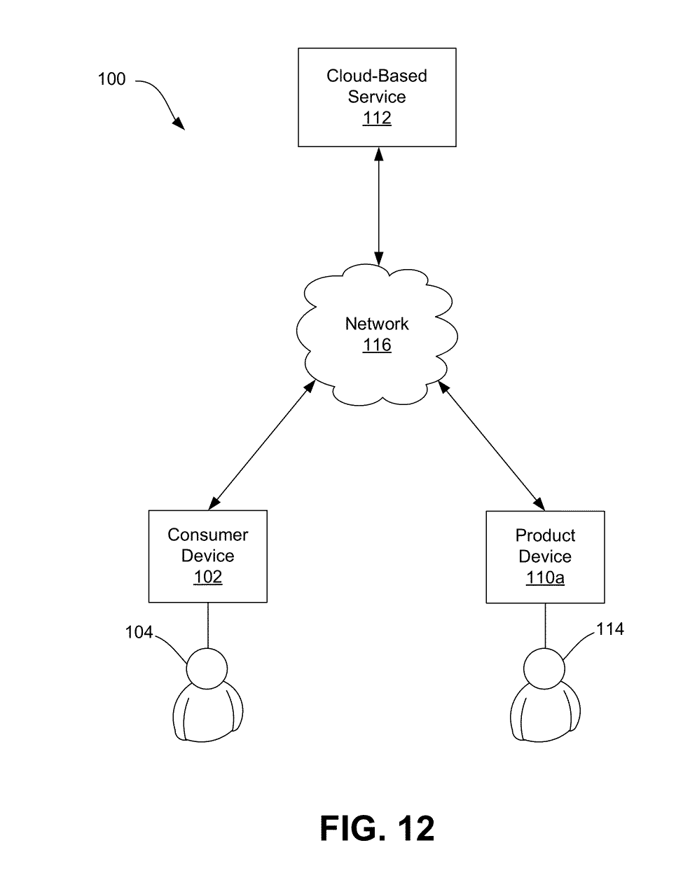

FIG. 12 is a block diagram illustrating one embodiment of an exemplary system 100 for increasing likelihood of a consumer purchasing a product within the retail space. As shown, the system 100 includes a cloud-based service 112 configured to communicate with and share data with at least the device 102 associated with the consumer 104 (hereinafter referred to as consumer device 102) and one or more devices 110 associated with the one or more products 106 (hereinafter product device 110) and a member of a supply chain 114 associated with the product device 110. The cloud-based service 112 is configured to communicate with the consumer and/or product devices 104, 110 over a network 116.

The consumer and/or product devices 102, 110 may include devices configured to wirelessly transmit data via a wireless transmission protocol. The wireless transmission protocol may include, but is not limited to, Bluetooth communication, infrared communication, near field communication (NFC), radio-frequency identification (RFID) communication, cellular network communication, the most recently published versions of IEEE 802.11 transmission protocol standards as of August 2015, and a combination of at least two thereof.

Additionally, or alternatively, the consumer and product devices 102, 110 may include devices configured to transmit data via a wire-based communication, such as a direct wired line of communication between the consumer and/or product device 102, 110 and a system configured to communicate with the cloud-based service 112. Some examples of wire-based communications may include, but are not limited to, telephone networks, cable television or internet access, fiber-optic communication, waveguide (electromagnetism), and a combination of at least two thereof.

The consumer device 102 and product device 110 may be embodied as any type of device for communicating with cloud-based service 112 and/or one another. For example, at least one of the consumer device 102 and product device 110 may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a network appliance, a web appliance, a distributed computing system, a multiprocessor system, a processor-based system, a consumer electronic device, and/or any other computing device configured to store and access data, and/or to execute software and related applications consistent with the present disclosure.

As described in greater detail herein, the cloud-based service 112 is configured to receive data from both the consumer device 102 and one or more of the product devices 110 and analyze the data to generate consumer data. The consumer data generally includes information about the consumer within the retail space and, in some instances, the consumer's level of interest with one or more of the products 106. The cloud-based service 112 is further configured to provide and output to at least one of the consumer 104 and a member of a supply chain associated with the one or more products based, at least in part, on the consumer data. The output may generally increase the likelihood of the consumer purchasing the one or more products.

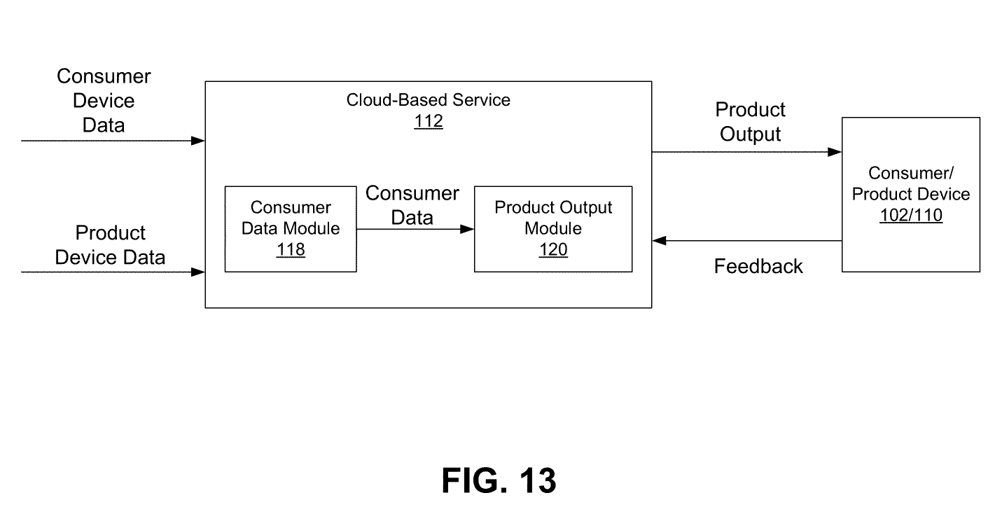

FIG. 13 is a block diagram illustrating the generation of consumer data based on the analysis of various sets of received data and the transmission of an output to a consumer device and/or member of a supply chain based on the consumer data. As shown, the cloud-based service 112 may include a consumer data module 118 configured to receive at least a first set of data associated with the consumer from the consumer device 102 (e.g., consumer device data). The first set of data may include, but is not limited to, location of the consumer within the retail space, movement of the consumer within the retail space, activity of the consumer within the retail space, consumer interaction with one or more products, purchase information of the consumer, identity information of the consumer, and a combination of at least two thereof.

In one embodiment, the consumer device 102 may include a form of a tracking cookie configured to track the movement of the consumer within the retail space with relation to a particular product and/or track the purchase of the product. Accordingly, in the event that the consumer device 102 is a smart phone, for example, the cookie may be configured to communicate with one or more components of the smart phone (e.g., accelerometer, gyroscope, GPS, etc.) to determine movement and location of the consumer and provide such information to the cloud-based service 112 for further processing and analysis. Such information may be relevant and useful for determining consumer interest in a product, thereby allowing the opportunity to increase the likelihood of a product purchase.

The consumer data module 118 is further configured to receive at least a second set of data associated with at least one product 106 from the product device 110 (e.g., product device data). The second set of data may include, but is not limited to, a location of the product within the retail space, identity of the product, movement of the product, consumer interaction with the product, consumer interaction with a display case associated with the product, removal of the product from the retail space, and a combination of at least two thereof.

In one embodiment, the product device 110 may include a sensor for detecting heat, such that the device 110 may be configured to track thermal profiles of one or more consumers in the retail space. The product device 110 may further rely on thermal analysis as a means of determining consumer interest in any given product. For example, the product device 110 may provide, as part of the second set of data, a thermal analysis by way of a heat map which shows that the consumer residing in front of a display case 108 and/or product 106 for a certain amount of time (based on the intensity of the heat profile). Accordingly, based on the thermal analysis, the consumer data may infer consumer interest in that particular product 106. It should be noted that the product device 110 may include other methods of consumer proximity detection.

The consumer data module 118 is configured to analyze the first and second sets of data and generate consumer data. The consumer data module 118 may include custom, proprietary, known and/or after-developed statistical analysis code (or instruction sets), hardware, and/or firmware that are generally well-defined and operable to receive one or more sets of data and identify, at least to a certain extent, a pattern related to consumer interest in the product 106. It should be noted that the cloud-based service 112 is configured to receive the first and second sets of data (consumer device data and product device data) in real-time and at least at one point in time during the consumer's time spent in the retail space. Additionally, or alternatively, the cloud-based service 112 is configured to receive the first and second sets of data in real-time and at least at two different points in time, so as to continuously generate accurate consumer data throughout a large portion of the time the consumer spends in the retail space.

The cloud-based service 112 may further include a product output module 120 configured to receive the consumer data and generate a product output for transmission to at least one of the consumer device 102 and product device 110. The product output module 120 may include custom, proprietary, known and/or after-developed statistical analysis code (or instruction sets), hardware, and/or firmware that are generally well-defined and operable to receive consumer data and identify, at least to a certain extent, a product output based on the consumer data, wherein the product output may increase the likelihood of the consumer 104 purchasing the product 106.

For example, the output may include, but is not limited to, product details, product promotions, product special offers, product coupons, product inventory, and a combination of at least two thereof. In the instance of providing output to the consumer device 102, and ultimately the consumer, the product output is provided to the consumer 104 by a delivery mechanism including, but not limited to, a speaker of the consumer device 102 and a display of the consumer device 102. For example, in an effort to persuade the consumer 104 to purchase the product 106 in which they possibly showed interest, based on the generated consumer data, a promotion sound clip may be transmitted from the cloud-based service 112, and/or the product device 110, to the consumer device 102 to be played by a speaker on the consumer device. Similarly, a video clip may be presented on a display of the consumer device 102, providing promotion details about the product 106, or a coupon for the product 106.

As described herein, the cloud-based service 112 is configured to continually provide consumer data to a member of a supply chain 114 and further provide output to the member, so as to allow the member to make a real-time decision based on the output. For example, in one embodiment, the cloud-based service 112 may be configured to communicate and share data with a device associated with one or more members of a supply chain 114 (hereinafter referred to as member device). Accordingly, the cloud-based service 112 is configured to allow one or more members of a supply chain 114 to access the consumer data so as to have real-time visibility related to a consumer and their interaction with one or more products. The member device may be embodied as any type of device for communicating with the cloud-based service 112 and/or other member devices over the network 116. For example, at least one of the member devices may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure.

In some embodiments, the consumer data and/or output may be presented to a member 114 via a display operably coupled to the member device, such that the member 114 is able to have real-time visibility to the consumer data. The member device may further provide an interface for allowing a member 114 to interact with the consumer data (e.g., filter, sort, access different sets of data, etc.). The cloud-based service 112 is configured to provide output to the member device based on the consumer data, wherein the output may be presented to the member 114 via the display of the member device. The member 114 may further interact with an interface displayed on the member device so as to make a decision, in real-time, as to whether to act on the output or not act on the output. The decision may result in the delivery of the product details, product promotions, product special offers, product coupons, and the like the one or more delivery mechanisms so as to persuade the consumer to purchase the product. For example, in addition to pushing sound, image, and/or video files to the consumer device 102, the member of the supply chain 114 may choose to push sound, image, and/or video files on speakers and/or displays within the retail space associated with the product 106. For example, a display case 108 may include one or more speakers and/or display screens. Additionally, or alternatively, display case 108 may further include adjustable price tags configured to wireless communicate with at least one of the cloud-based service 112 and product device 110, such that the member of the supply chain 114 may be able to adjust the price of a product in real-time to persuade the consumer 104 to purchase the product 106.

The cloud-based service 112 is further configured to receive a third set of data in the form of feedback from the consumer device 102 and/or product device 110 as to whether the consumer purchased the product. In some embodiments, the cloud-based service 112 may receive and include the third set of data with at least the first and second sets of data during an analysis thereof, thereby improving generation of the consumer data, which may improve the identification of a consumer's interest level. Furthermore, a member of a supply chain may use this additional information for the purposes of realizing inventory and whether a product requires re-stocking and/or reordering.

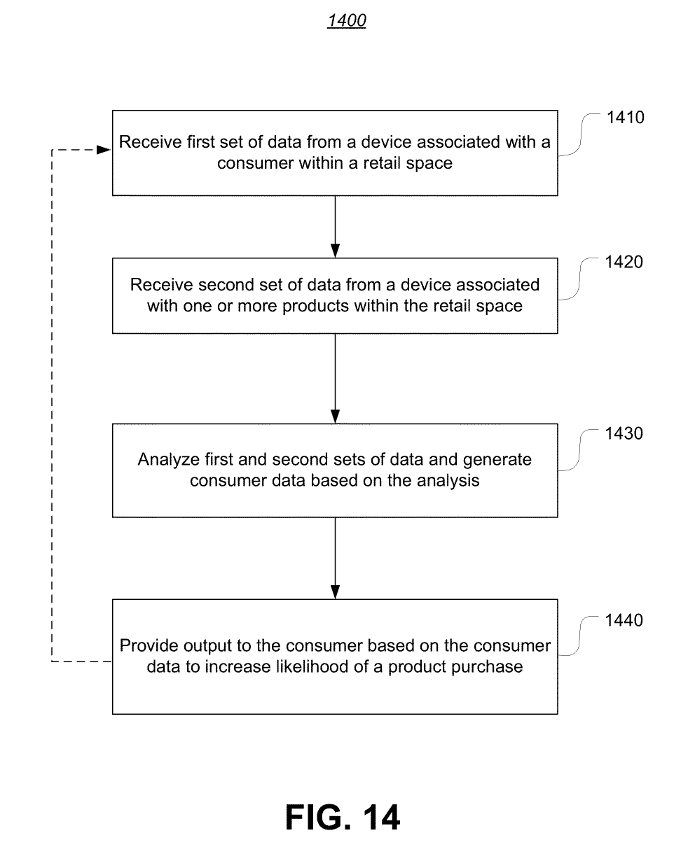

FIG. 14 is a flow illustrating an embodiment of a method for increasing likelihood of a consumer purchasing a product. The method 1400 includes receiving a first set of data from a device associated with a consumer in a retail space (operation 1410). The first set of data includes, but is not limited to, location of the consumer within the retail space, movement of the consumer within the retail space, activity of the consumer within the retail space, consumer interaction with one or more products, purchase information of the consumer, identity information of the consumer, and a combination of at least two thereof. The method 1400 further includes receiving a second set of data from a device associated with one or more products within the retail space (operation 1420). The second set of data includes, but is not limited to, a location of the product within the retail space, identity of the product, movement of the product, consumer interaction with the product, consumer interaction with a display case associated with the product, removal of the product from the retail space, and a combination of at least two thereof. The method 1400 further includes analyzing the first and second sets of data and generating consumer data based on the analysis (operation 1430). The consumer data may provide an indication of the consumer's interest level in one or more of the products. The method 1400 further includes providing output to the consumer based on the consumer data to increase the likelihood of a product purchase (operation 1440). The output may include the delivery of product details, product promotions, product special offers, product coupons, and the like the one or more delivery mechanisms so as to persuade the consumer to purchase the product.

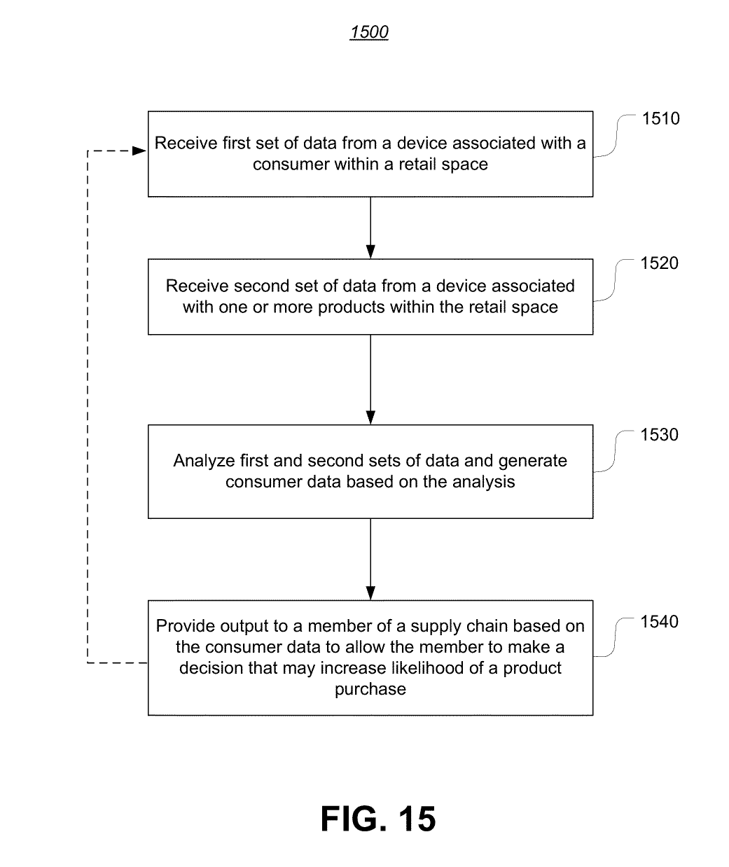

FIG. 15 is a flow illustrating an embodiment of a method for increasing likelihood of a consumer purchasing a product. The method 1500 includes receiving a first set of data from a device associated with a consumer in a retail space (operation 1510). The first set of data includes, but is not limited to, location of the consumer within the retail space, movement of the consumer within the retail space, activity of the consumer within the retail space, consumer interaction with one or more products, purchase information of the consumer, identity information of the consumer, and a combination of at least two thereof. The method 1500 further includes receiving a second set of data from a device associated with one or more products within the retail space (operation 1520). The second set of data includes, but is not limited to, a location of the product within the retail space, identity of the product, movement of the product, consumer interaction with the product, consumer interaction with a display case associated with the product, removal of the product from the retail space, and a combination of at least two thereof. The method 1500 further includes analyzing the first and second sets of data and generating consumer data based on the analysis (operation 1530). The consumer data may provide an indication of the consumer's interest level in one or more of the products. The method 1500 further includes providing output to a member of a supply chain based on the consumer data to allow the member to make a decision that may increase the likelihood of a product purchase (operation 1540). The decision may result in the delivery of product details, product promotions, product special offers, product coupons, and the like the one or more delivery mechanisms so as to persuade the consumer to purchase the product.

While FIGS. 14 and 15 illustrate method operations according various embodiments, it is to be understood that in any embodiment not all of these operations are necessary. Indeed, it is fully contemplated herein that in other embodiments of the present disclosure, the operations depicted in FIGS. 14 and 15 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method for increasing likelihood of an on-time delivery of cargo, the method comprising:
receiving a first set of data associated with one or more objects that move in space and time that transport cargo;
receiving a second set of data associated with one or more destinations for the cargo;
analyzing the first and second sets of data to thereby generate delivery data related to a scheduled delivery for the cargo; and
providing a suggested action to a member of a supply chain based on the delivery data to thereby allow the member of the supply chain to make a real-time decision that increases a likelihood of an on-time delivery of the cargo.

2. The method according to claim 1, wherein the one or more objects that move in space and time are one or more vehicles, wherein the one or more vehicles are selected from the group consisting of: a bicycle, an automobile, an aircraft, a watercraft, a locomotive, and a combination of at least two thereof.

3. The method according to claim 2, wherein the first set of data is selected from the group consisting of: identity of the vehicle, location of the vehicle, fuel consumption of the vehicle, environment around the vehicle, environment within the vehicle, movement of the vehicle, capacity of the vehicle, operational status of the vehicle, itinerary of the vehicle, owner of the vehicle, operator of the vehicle, and a combination of at least two thereof.

4. The method according to claim 2, wherein the suggested action is selected from the group consisting of: modify vehicle speed, modify vehicle route, modify destination location, modify scheduled delivery for the cargo, modify scheduled departure time for cargo, modify mode of transit for cargo, modify the itinerary, modify the carrier of the mode of transit, and a combination of at least two thereof.

5. The method according to claim 1, wherein the second set of data is selected from the group consisting of: identity of the destination, location of the destination, overall capacity of the destination, current capacity of the destination, seasonality of the destination, operational status of the destination, schedule of the destination, operator of the destination, current weather at the destination, predicted weather at the destination, current working conditions at the destination, predicted working conditions at the destination, location of one or more types of vehicles arriving at the destination, and a combination of at least two thereof.

6. The method according to claim 1, wherein the first and second sets of data are received in real-time and at least at one point in time.

7. The method according to claim 1, further comprising receiving a third set of data that comprises a news feed or other external sources of logistics impacting data, wherein the third set of data is analyzed with the first and second sets of data to generate the delivery data.

8. The method according to claim 7, further comprising receiving a fourth set of data that comprises feedback as to whether a member of a supply chain acted on the suggested action, wherein the fourth set of data is analyzed with the first, second, and third sets of data to generate the delivery data.

9. A method for increasing likelihood of a consumer purchasing a product, the method comprising:
receiving a first set of data of a consumer within a retail space from a device associated with the consumer and that is able to transmit the first set of data;
receiving a second set of data associated with a product within the retail space from a device operably associated with the product and that is able to transmit the second set of data;
analyzing the first and second sets of data to thereby generate consumer data; and
providing an output to the consumer based on the consumer data that may increase likelihood of the consumer purchasing the product.

10. The method according to claim 9, wherein the first set of data is selected from the group consisting of: location of the consumer within the retail space, movement of the consumer within the retail space, activity of the consumer within the retail space, consumer interaction with one or more products, purchase information of the consumer, identity information of the consumer, and a combination of at least two thereof.

11. The method according to claim 9, wherein the second set of data is selected from the group consisting of: location of the product within the retail space, identity of the product, movement of the product, consumer interaction with the product, consumer interaction with a display case associated with the product, removal of the product from the retail space, and a combination of at least two thereof.

12. The method according to claim 9, wherein the first and second sets of data are received in real-time and at least at one point in time.

13. The method according to claim 9, further comprising receiving a third set of data that comprises feedback as to whether a consumer purchased the product, wherein the third set of data is analyzed with the first and second sets of data to generate the consumer data.

14. The method according to claim 9, wherein the output is selected from the group consisting of: product details, product promotions, product special offers, product coupons, product inventory, and a combination of at least two thereof, and wherein the output is provided to the consumer by at least one delivery mechanism selected from the group consisting of: a speaker of a consumer mobile device, a display of a consumer mobile device, a speaker within the retail space, a display within the retail space, and a combination of at least two thereof.

15. A method for providing consumer data to a member of a supply chain, the method comprising:
receiving a first set of data of a consumer within a retail space from a device associated with the consumer and that is able to transmit the first set of data;
receiving a second set of data associated a product within the retail space from a device operably associated with the product and that is able to transmit the second set of data;
analyzing the first and second sets of data to thereby generate consumer data; and
providing an output to a member of a supply chain based on the consumer data to thereby allow the member of the supply chain to make a decision that may increase likelihood of the consumer purchasing the product.

16. The method according to claim 15, wherein the first set of data is selected from the group consisting of: location of the consumer within the retail space, movement of the consumer within the retail space, activity of the consumer within the retail space, consumer interaction with one or more products, purchase information of the consumer, identity information of the consumer, and a combination of at least two thereof.

17. The method according to claim 15, wherein the second set of data is selected from the group consisting of: location of the product within the retail space, identity of the product, movement of the product, consumer interaction with the product, consumer interaction with a display case associated with the product, removal of the product from the retail space, and a combination of at least two thereof.

18. The method according to claim 15, wherein the first and second sets of data are received in real-time and at least at one point in time.

19. The method according to claim 15, further comprising receiving a third set of data that comprises feedback as to whether a consumer purchased the product, wherein the third set of data is analyzed with the first and second sets of data to generate the consumer data.

20. The method according to claim 15, wherein the decision includes output provided to the consumer selected from the group consisting of: product details, product promotions, product special offers, product coupons, product inventory, and a combination of at least two thereof, wherein the output is provided to the consumer by at least one delivery mechanism selected from the group consisting of: a speaker of a consumer mobile device, a display of a consumer mobile device, a speaker within the retail space, a display within the retail space, and a combination of at least two thereof.
